(19) United States
(12) Patent Application Publication
(10) Pub. No.: US 2022/0128505 A1
(43) Pub. Date: Apr. 28, 2022

(54) ION CONCENTRATION ELECTRODE ASSEMBLY WITH ACTUATOR FOR SELECTIVELY OPENING LIQUID JUNCTION

(71) Applicant: Thermo Orion Inc., Chelmsford, MA (US)

(72) Inventors: Anders Rasmuson, Worcester, MA (US); Aaron Veino, Andover, MA (US)

(21) Appl. No.: 17/078,503

(22) Filed: Oct. 23, 2020

(51) Int. Cl. G01N 27/28; G01N 27/333; G01D 11/24; G01N 27/416

(52) U.S. Cl. CPC G01N 27/283; G01N 27/4167; G01D 11/245; G01N 27/333

(57) ABSTRACT

An electrode assembly includes a hollow outer body, a cap, a biasing assembly, an actuator, and a sensing electrode having a hollow stopper at a lower end thereof. The outer body includes a lower edge that defines a lower opening. The cap is fixedly coupled to the outer body so that the cap does not move with respect to the hollow outer body. The biasing assembly is operatively coupled to the hollow outer body and the sensing electrode, and urges the sensing electrode upward so that an outer surface of the stopper is normally in contact with the lower edge of the outer body. The actuator is configured to move relative to the outer body so that when force is applied to the actuator, the stopper separates from the lower edge of the outer body, thereby allowing an electrolytic solution to flow out of the outer body.

### FIELD OF THE INVENTION

The present invention generally relates to ion concentration probes and, in particular, to an electrode assembly that can be purged of a reference filling electrolytic solution through a selectively openable liquid junction.

### BACKGROUND OF THE INVENTION

Electrode-based ion measurement systems typically include an electrode assembly having a sensing electrode responsive to the specific ions being measured, and a reference electrode that provides a stable potential against which the sensing electrode potential is measured. In the case of a pH measurement system, the sensing electrode is commonly a glass-based pH electrode. In order to measure the concentration of a particular ion or group of ions in a sample solution (such as H⁺ ions in the case of a pH measurement), the electrode assembly is immersed in the sample solution.

Each of the sensing and reference electrodes may contain an electrolytic solution and a conductor that is immersed in the electrolytic solution to form a voltaic half-cell. Reference electrodes containing an electrolyte also typically include a diaphragm that couples the electrolyte with the sample solution to complete the circuit. When the electrode assembly is immersed in the sample solution, a potential is created at the sensing electrode that is dependent on the specific ionic concentration of the sample solution. The reference electrode, on the other hand, is configured to generate a constant potential against which the potential of the sensing electrode is compared. To determine the ionic concentration in the sample solution, the conductors of the electrodes are connected to a voltmeter. The voltmeter then measures the difference in potential between the sensing and reference electrodes, which provides an indication of the specific ionic concentration of the sample solution. Thus, in order to obtain an accurate measurement of the ionic concentration, the reference electrode must provide a constant reference potential.

Because the potential generated by the reference electrode is a combination of the electrode potential in the reference electrolyte and the liquid-liquid junction potential between the electrolyte-sample interface, both potentials need to be constant. One way to maintain a constant junction potential between the electrolyte-sample interface is to minimize the development of a diffusion potential by continuously refreshing the interface with a controlled positive flow of the reference electrolyte into the sample solution through the liquid-liquid junction. One type of electrode design that provides a positive flow of reference electrolyte, resists clogging, and is easy to clean is known as a Sure-Flow™ pH electrode, which is available from Thermo-Fisher Scientific of Waltham Mass., United States.

The reference electrode of a Sure-Flow™ pH electrode assembly typically includes a body with a larger diameter than the body of the sensing electrode so that the sensing electrode can be located coaxially within the reference electrode body. This configuration allows a liquid junction to be formed between the distal ends of the conductors of the sensing and reference electrodes. When the electrode assembly is submerged in the sample solution, electrolyte flows across the junction so that a voltaic cell is formed between the electrode assembly and the sample solution.

The liquid junction of a Sure-Flow™ pH electrode assembly typically comprises a glass-to-glass coupling between the sensing electrode body and the reference electrode body that can be selectively opened or closed. When the coupling is closed, a liquid junction is formed that enables the electrolytic solution to slowly flow out of the electrode. Opening the coupling allows the electrolytic solution to rapidly flow out of the electrode. Opening the coupling thereby enables the operator to replace electrolytic solution that may have become contaminated through use, as well as clean the interface, which may have become soiled or clogged.

Conventional electrode assemblies require the user to hold onto the outer tube of the reference electrode while pressing on a floating cap at the top of the assembly in order to move the sensing electrode out of contact with the reference electrode. This is typically a two-handed operation. Attempting to open the electrode assembly using one hand can lead to the electrode assembly being dropped and potentially broken. The need to use two hands is an inconvenience, and often requires the user to set down an object, such as a writing implement for taking notes, to free-up their hand to operate the electrode assembly. The need to touch the outer surface of the reference electrode body can also lead to contamination of the electrode assembly.

Thus, there is a need for improved apparatuses and methods for purging electrolytic solution from electrode assemblies used in ion measurement systems.

### SUMMARY OF THE INVENTION

In an embodiment of the invention, an electrode assembly is provided. The assembly includes a hollow outer body, a cap, a biasing assembly, an actuator, and a sensing electrode. The outer body includes an upper portion and a lower end having an edge that defines a lower opening. The cap is operatively coupled to the upper portion of the hollow outer body such that the cap has a fixed relationship with the hollow outer body. The biasing assembly is configured to provide a first force, and is operatively coupled to one or more of the hollow outer body and the cap. The actuator is operatively coupled to the biasing assembly such that the first force urges the actuator into a first position relative to the hollow outer body. The sensing electrode is operatively coupled to the actuator and includes a stopper having an outer surface that abuts the edge of the hollow outer body when the actuator is in the first position.

In an aspect of the invention, the actuator is configured to, in response to application of a second force to the actuator in opposition to and sufficient to overcome the first force, move from the first position to a second position relative to the hollow outer body. This movement by the actuator causes the outer surface of the stopper to separate from the edge of the hollow outer body.

In another aspect of the invention, the hollow outer body defines a chamber that contains a filling electrolytic solution, and a liquid junction is formed between the outer surface of the stopper and the edge of the hollow outer body when the electrode assembly is immersed in a sample solution. The liquid junction operatively couples the filling electrolytic solution to the sample solution.

In another aspect of the invention, the cap includes an upper opening, and the actuator includes a button that extends upward through the upper opening.

In another aspect of the invention, the electrode assembly further includes a cable assembly including a cable, and the button includes a passage configured to pass the cable.

In another aspect of the invention, the sensing electrode includes a hollow inner body having an upper end, and the actuator includes a sleeve having a channel configured to receive the upper end of the hollow inner body.

In another aspect of the invention, the cable includes a distal end and a conductor, the upper end of the hollow inner body includes an inner body opening, and the sensing electrode includes a sensing lead having a proximal end. The proximal end of the sensing lead includes an elastic feature positioned in the hollow inner body of the sensing electrode proximate to the inner body opening. The distal end of the cable is positioned in the channel of the sleeve opposite the inner body opening so that conductor extends from the cable into the inner body opening a distance sufficient to compress the elastic feature of the proximal end of the sensing electrode.

In another aspect of the invention, the sleeve includes an annular groove, and the biasing assembly includes an elastic member having a first end and a second end. The first end of the elastic member is operatively coupled to the one or more of the hollow outer body and the cap. A retaining ring is positioned in the annular groove of the sleeve and operatively coupled to the second end of the elastic member.

In another aspect of the invention, the first end of the elastic member is operatively coupled to the upper end of the hollow outer body.

In another aspect of the invention, the sleeve includes another annular groove, and the hollow outer body includes an inner surface. An O-ring positioned in this annular groove provides a fluidic seal between the sleeve and the inner surface of the hollow outer body.

In another aspect of the invention, the sleeve has a bore on the lower end thereof. A bushing is positioned in the bore of the sleeve, and operatively couples the hollow inner body to the sleeve.

In another aspect of the invention, the cap includes an upper opening. The actuator includes a button having a button upper portion that extends upward through the upper opening, and a button lower portion that is operatively coupled to the sleeve.

In another aspect of the invention, the hollow inner body includes an outer surface, and the sleeve includes an annular recess between the bore and the channel. An O-ring positioned in the annular recess provides a fluidic seal between the sleeve and the outer surface of the inner body.

In another aspect of the invention, the hollow outer body includes a fill-hole, and a plug is tethered to the hollow outer body for selectively sealing the fill-hole.

In another aspect of the invention, a helical tube is positioned in the hollow outer body, and the sensing electrode extends axially through the helical tube.

In another aspect of the invention, the helical tube contains a reference electrolytic solution.

In another aspect of the invention, the hollow outer body defines a chamber containing a filling electrolytic solution, and the helical tube is capped by a porous plug that provides a liquid junction between the reference electrolytic solution and the filling electrolytic solution.

In another aspect of the invention, the sensing electrode contains a sensing electrolytic solution.

In another aspect of the invention, the hollow inner body of the sensing electrode extends axially through the hollow outer body, and the sensing electrode includes a membrane. The membrane is coupled to the hollow inner body by the stopper, and extends axially outward from the lower end of the hollow outer body.

In another aspect of the invention, the sensing electrode includes a cylindrical section that operatively couples the membrane to the stopper.

The above summary presents a simplified overview of some embodiments of the present invention to provide a basic understanding of certain aspects thereof that are discussed herein. The summary is not intended to provide an extensive overview of the present invention, nor is it intended to identify any key or critical elements, or delineate the scope of the present invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate certain embodiments of the present invention and, together with a general description of the invention given above, and the detailed description given below, serve to explain the invention.

FIG. 1 is a perspective view of an electrode assembly in accordance with an embodiment of the present invention.

FIG. 2 is a partially disassembled perspective view of the electrode assembly of FIG. 1 depicting a sensing electrode of the electrode assembly.

FIG. 3 is a cross-sectional schematic view of the electrode assembly of FIG. 1 with the sensing electrode in a closed position.

FIG. 3A is an enlarged view of portions of the electrode assembly of FIG. 3 showing additional details thereof.

FIG. 4 is a cross-sectional schematic view of the electrode assembly of FIG. 1 with the sensing electrode in an open position.

### DETAILED DESCRIPTION OF THE INVENTION

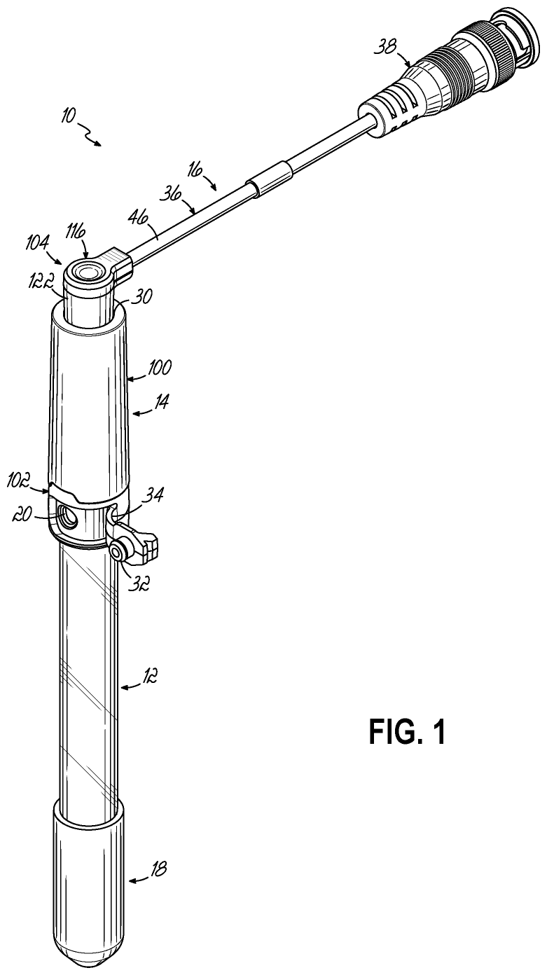

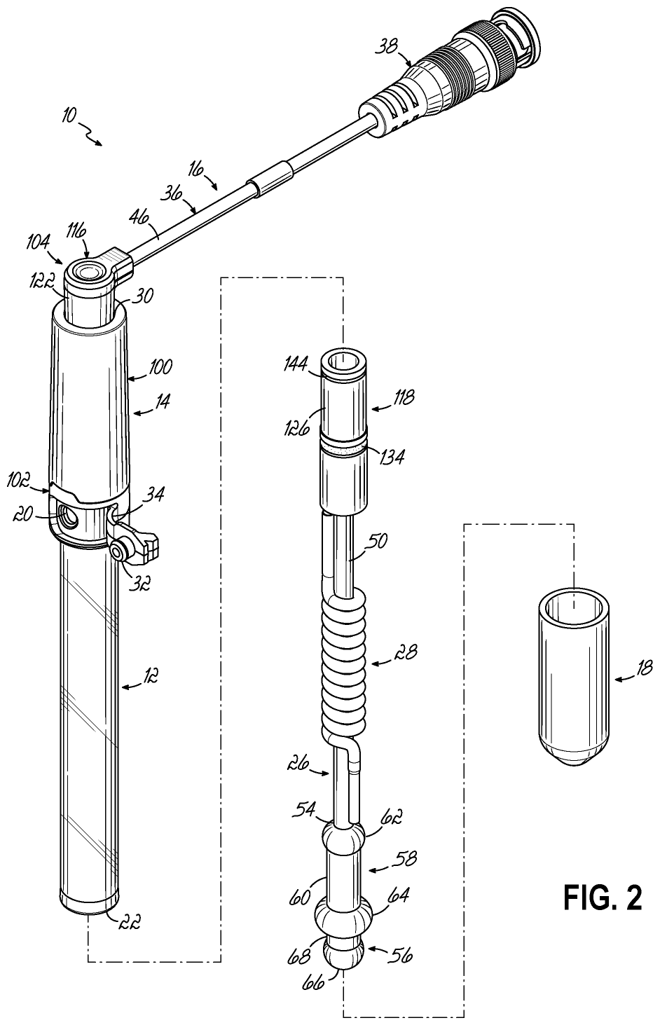

FIGS. 1-3A depict an electrode assembly 10 in accordance with an embodiment of the present invention that includes a hollow outer body 12, a cap 14, a cable assembly 16, and a protective cover 18. The outer body 12 may include a fill-hole 20 in an upper portion thereof, and a lower edge 22 that defines a lower opening 24 thereof. The outer body 12 may house a sensing electrode 26 and a helical tube 28 that is coiled around an upper portion of the sensing electrode 26. The cap 14 may include an upper opening 30, and a plug 32 that is operatively coupled to the outer body 12 by a tether 34. The plug 32 may be configured to selectively fluidically seal the fill-hole 20 of outer body 12. The protective cover 18 may have a friction-fit with the outer body 12 that enables the protective cover 18 to be selectively removed (e.g., prior to using the electrode assembly 10) and replaced (e.g., after use of the electrode assembly 10).

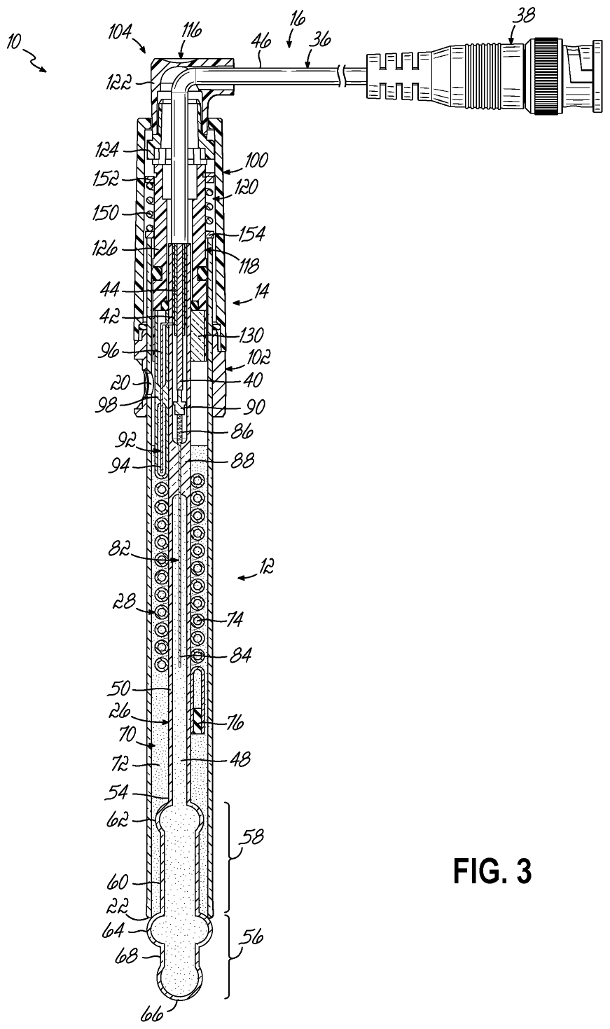

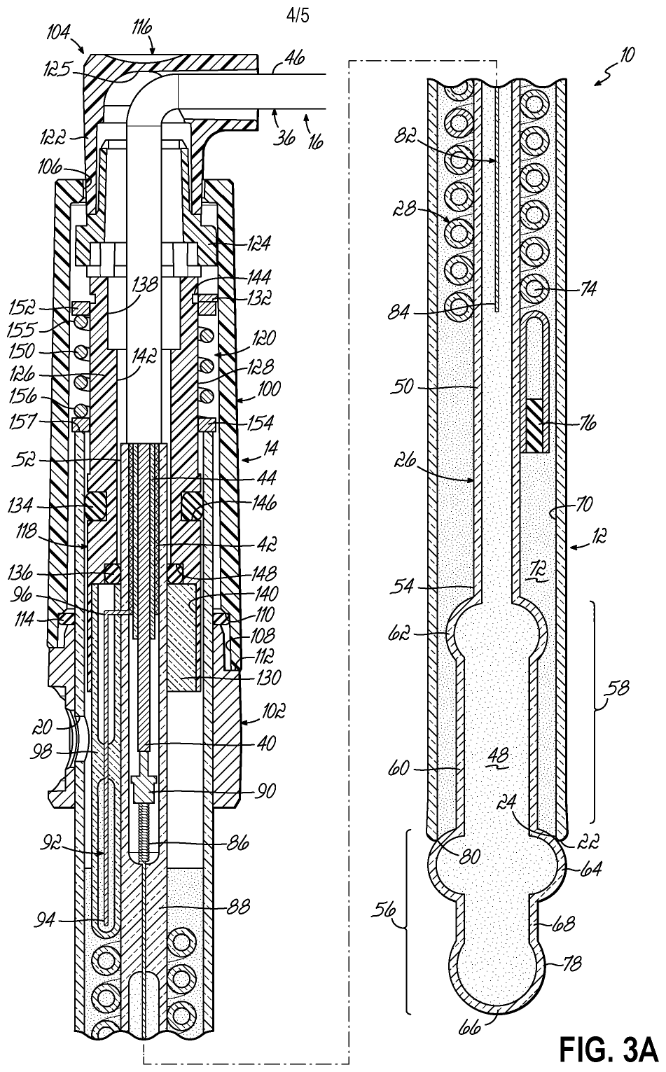

The cable assembly 16 may include a cable 36 and a connector 38. The connector 38 may be a coaxial connector, such as a Bayonet Neill-Concelman (BNC) connector. The cable 36 may include a center conductor 40 (e.g., a metallic core) as shown in FIG. 3 that is separated from an outer conductor 42 (e.g., a woven metallic shield) by an insulating layer 44, and an outer sheath 46. The center conductor 40 and outer conductor 42 may be operatively coupled to the connector 38 to facilitate connecting the electrode assembly 10 to a laboratory instrument, such as benchtop meter.

The sensing electrode 26 extends axially through the outer body 12 and helical tube 28, and is filled with a sensing electrolytic solution 48 (see FIG. 3). The sensing electrode 26 includes hollow inner body 50 having an upper end 52 and a lower end 54, and a lower portion 56 that projects outwardly from the lower opening 24 of outer body 12. The lower portion 56 of sensing electrode 26 may be operatively coupled to the lower end 54 of inner body 50 by an upper chamber 58. The upper chamber 58 may include a cylindrical section 60 having a diameter larger than the inner body 50, and an onion-shaped section 62 that fluidically couples the cylindrical section 60 to the lower end 54 of inner body 50. The lower portion 56 of sensing electrode 26 may include a bulbous, hollow stopper 64, a generally spherical membrane 66, and a cylindrical section 68 that fluidically couples the stopper 64 to the membrane 66.

A chamber 70 defined by the unoccupied space within the outer body 12 may be filled with a filling electrolytic solution 72, and the helical tube 28 may be filled with a reference electrolytic solution 74. A lower end of the helical tube 28 may be capped by a porous plug 76. The filling electrolytic solution 72 may be provided to the chamber 70 through the fill-hole 20. The chamber 70 may be filled with an amount of the filling electrolytic solution 72 sufficient to immerse the porous plug 76 so that the porous plug 76 provides a fluid junction between the filling electrolytic solution 72 and the reference electrolytic solution 74.

The stopper 64 may have an outer surface 78 sized and shaped so that, when the sensing electrode 26 is in a closed position, the outer surface 78 of the stopper 64 abuts the lower edge 22 of outer body 12 to form an annular liquid junction 80 therebetween. The liquid junction 80 may allow diffusion of ions between the filling electrolytic solution 72 and the sample solution when the electrode assembly 10 is immersed in the sampling solution. This diffusion may enable an exchange of ions between the filling electrolytic solution 72 and sample solution, which may in turn provide a reference potential. The reference potential may provide a voltage against which a potential generated by the sensing electrode 26 can be measured.

The sensing electrolytic solution 48 may be electrically coupled to the center conductor 40 of cable assembly 16 by a sensing lead 82. The sensing lead 82 may comprise a wire (e.g., a platinum wire), or other suitable conductor that extends into the sensing electrode 26. The sensing lead 82 may include a distal end 84 and a proximal end 86. The sensing lead 82 may pass through a seal 88 (e.g., a glass seal) so that the distal end 84 thereof extends a distance into the sensing electrode 26 sufficient to contact the sensing electrolytic solution 48. The proximal end 86 of sensing lead 82 may comprise a helical winding or other elastic feature that operatively couples the sensing lead 82 to the center conductor 40 of cable assembly 16. To this end, a contact 90 may be operatively coupled (e.g., soldered or crimped) to an end of the center conductor 40. As the end of the cable assembly 16 is inserted into a top opening of sensing electrode 26, the contact 90 may come into contact with and compress the proximal end 86 of sensing lead 82 against the seal 88. The compressive force between the proximal end 86 and contact 90 may ensure that good electrical coupling is maintained between the sensing lead 82 and center conductor 40 of cable assembly 16.

The reference electrolytic solution 74 may be electrically coupled to the outer conductor 42 of cable assembly 16 by a reference lead 92. The reference lead 92 may comprise a wire (e.g., a platinum wire), or other suitable conductor that extends into the helical tube 28. The reference lead 92 may include a distal end 94 and a proximal end 96. The distal end 94 of reference lead 92 may pass through a seal 98 (e.g., a glass seal), and extend a distance into the helical tube 28 sufficient to contact the reference electrolytic solution 74. The proximal end 96 of reference lead 92 may be operatively coupled to the outer conductor 42 of cable assembly 16 in a suitable manner, such as by wrapping a portion of the proximal end 96 around the outer conductor 42 of cable assembly 16, soldering the proximal end 96 to the outer conductor 42, or both wrapping and soldering the proximal end 96 to the outer conductor 42.

The cap 14 may include an upper sleeve 100, a lower sleeve 102, and an actuator 104. The upper sleeve 100 may have an inner surface, an outer surface, a top opening 106, and a bottom opening 108. The bottom opening 108 may include a counterbore that defines a shoulder 110 in the interior surface of upper sleeve 100. The upper sleeve 100 may be generally cylindrical, and may have a taper such that the diameter of a lower portion of the outer surface is greater than the diameter of an upper portion of outer surface.

The lower sleeve 102 may include the plug 32 and the tether 34, and may have an inner surface sized and shaped so as to provide a friction fit with the outer surface of outer body 12. The cap 14 may have a fixed relationship to the outer body. To this end, one or more of the upper sleeve 100 and lower sleeve 102 may be epoxied or otherwise fixedly coupled to the outer body 12 so that the cap 14 does not move relative to the outer body 12. An upper portion of the lower sleeve 102 may have an outer diameter configured to fit within the counter bore of upper sleeve 100. A lower portion of the lower sleeve 102 may have an outer diameter that is generally the same as the outer diameter of the lower portion of upper sleeve 100 to provide a smooth transition between the outer surfaces of the upper and lower sleeves 100, 102. A shoulder 112 defined by a transition between the upper and lower portions of the lower sleeve 102 may provide a stop against which a lower edge of the upper sleeve 100 rests when the lower sleeve 102 is mated with the upper sleeve 100. An O-ring 114 or other suitable elastic member may be positioned between the shoulder 110 of upper sleeve 100 and an upper edge of the lower sleeve 102 to provide a fluidic seal between the cap 14 and the outer surface of outer body 12.

The actuator 104 may include a button 116, a coupler 118, and a biasing assembly 120. The button 116 may include an upper portion 122 and a lower portion 124, and provides a passage 125 through which the cable 36 passes into the electrode assembly 10. The upper portion 122 of button 116 may include an elbow that receives and provides strain relief to the cable 36. The lower portion 124 of button 116 may be configured to operatively couple the upper portion 122 of button 116 to the coupler 118.

The coupler 118 may include a sleeve 126 having an outer surface 128, a bushing 130, a retaining ring 132, an upper O-ring 134, and a lower O-ring 136. The sleeve 126 may include an upper bore 138 and a lower bore 140 connected by a channel 142. The sleeve 126 may further include an upper annular groove 144 and a lower annular groove 146 in its outer surface 128, and an annular recess 148 on its inner surface between the lower bore 140 and channel 142.

The lower bore 140 of sleeve 126 may be configured to receive the bushing 130 of coupler 118. The bushing 130 may be configured to operatively couple the inner body 50 of sensing electrode 26 to the coupler 118. The channel 142 connecting the upper and lower bores 138, 140 may be configured receive a top portion of the inner body 50 of sensing electrode 26 and a distal end of the cable 36.

The upper annular groove 144 may be configured to receive the retaining ring 132, the lower annular groove 146 may be configured to receive the upper O-ring 134, and the annular recess 148 may be configured to receive the lower O-ring 136. The upper O-ring 134 may provide a fluidic seal with an inner surface of the outer body 12. The lower O-ring 136 may provide a fluidic seal with an outer surface of the inner body 50 of sensing electrode 26.

The biasing assembly 120 may include an elastic member 150 (e.g., a helical spring), an upper retainer 152, and a lower retainer 154. The upper retainer 152 may operatively couple an upper end 155 of the elastic member 150 to the retaining ring 132 of coupler 118. A lower retainer 154 may operatively couple a lower end 156 of the elastic member 150 to a top edge 157 of outer body 12. The actuator 104 may be configured so that, absent any force being applied to the button 116, the biasing assembly 120 urges the actuator 104 into a position such that the stopper 64 abuts the lower edge 22 of outer body 12. When sufficient force is applied to the button 116 to overcome the force provided by the biasing assembly 120, the actuator 104 may move into a position such that the stopper 64 is separated from the lower edge 22 of outer body 12.

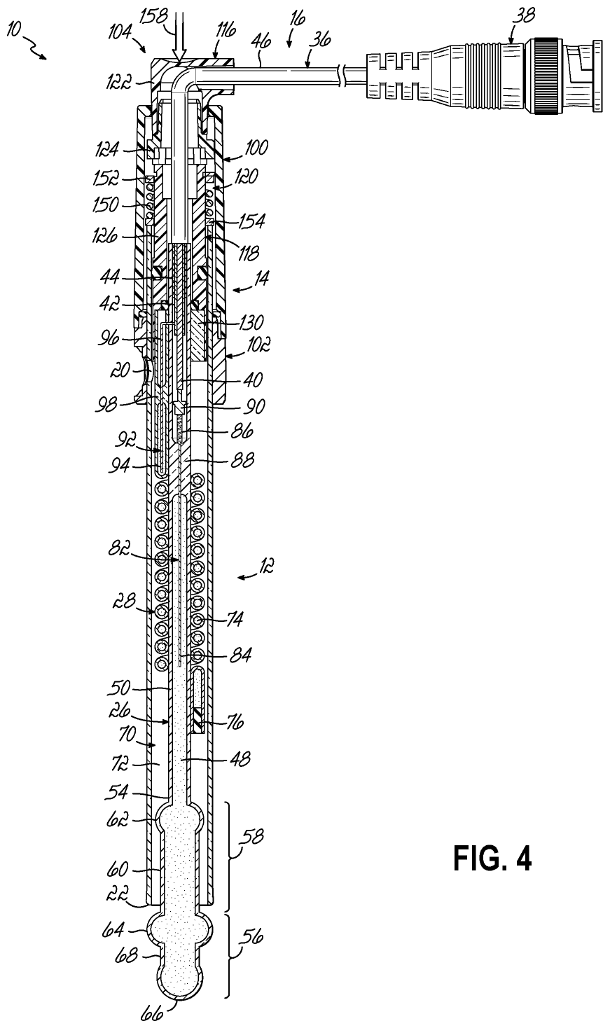

FIG. 4 depicts the electrode assembly 10 with the sensing electrode 26 in an open position. The electrode assembly 10 may normally be in a closed state due to the biasing assembly 120 urging the sensing electrode 26 in an upward direction. The elastic member 150 of biasing assembly 120 may apply a force in opposing directions against the upper and lower retainers 152, 154. The lower retainer 154 of biasing assembly 120 may communicate the force it receives from the elastic member 150 to the top edge 157 of outer body 12. The upper retainer 152 of biasing assembly 120 may communicate the force it receives from the elastic member 150 to the coupler 118 through the retaining ring 132 and upper annular groove 144 of sleeve 126. The coupler 118, in turn, may communicate this upward force to the sensing electrode 26 through the bushing 130 and lower O-ring 136. These opposing forces may thereby urge the stopper 64 into contact with the lower edge 22 of outer body 12.

A downward force 158 applied to the button 116 of actuator 104 may be communicated to the elastic member 150 through the actuator 104 and coupler 118. If the force 158 is sufficient, it may overcome the opposing force provided by the elastic member 150. As a result, the elastic member 150 may be compressed, and the sensing electrode 26 and helical tube 28 may move downward so that the stopper 64 becomes separated from the lower edge 22 of outer body 12. The downward force 158 may thereby place the electrode assembly 10 into an open state during which the filling electrolytic solution 72 is free to flow out of the chamber 70. Once the chamber 70 has emptied of the filling electrolytic solution 72, fresh filling electrolytic solution 72 may be added through the fill-hole 20.

The electrode assembly 10 may be assembled in several steps. By way of example, an assembly procedure may include inserting a clean dry pipe cleaner having a suitable diameter (e.g., 2 inches) into a top portion of the outer body 12. The pipe cleaner may be removed immediately prior to inserting the elastic member 150 and cable 36. The cable 36 of cable assembly 16 may be pre-stripped, and may be fed through the upper and lower portions 122, 124 of button 116. The upper and lower portions 122, 124 of button 116 may then be joined, e.g., using an adhesive, and the distal end of the cable 36 prepared for coupling to the sensing and reference leads 82, 92.

Preparation of the cable may include cutting a length (e.g., about 0.75 inches) of tubing (e.g., silicon tubing), cutting a vertical slit down one side of the tubing, and placing the tubing a distance (e.g., about 1 inch) above the end of the outer sheath 46 of cable 36. A jig may be used to ensure that the cable 36 is inserted the proper distance into the coupler 118, and the outer conductor 42 of cable 36 trimmed to a suitable length, e.g., 0.4 inches. An exposed portion of the proximal end 96 of reference lead 92 may then be wrapped around and soldered to the outer conductor 42, and any excess portions of the outer conductor 42 cut off.

After the reference lead 92 has been connected to the outer conductor 42 of cable 36, the cable 36 may be further inserted into the sensing electrode 26 and coupler 118 by a distance sufficient to compress the proximal end 86 of sensing lead 82 by a predetermined amount, e.g., between 0.1 and 0.5 inches. Voids within the coupler 118 may then be filled in with a suitable material, such as an epoxy, and allowed to cure. The cap 14 may then be slid down the cable 36 and into position.

Once the cap 14 is in place on the outer body 12, the electrode assembly 10 may be filled by adding 0.5 ml of a three-molar solution of potassium chloride through the fill-hole 20. A length of polyimide film tape (e.g., Kapton tape) may be wrapped around the outer body 12 so that the tape covers the fill-hole 20. A short tab (e.g., 0.5 inches) may be added to an end of the tape by folding over a section of the tape onto itself prior to wrapping the tape around the outer body 12. The cable 36 may then be lubricated with a suitable lubricant (e.g., silicon grease), and an adhesive (e.g., epoxy) applied to the outer surface of outer body 12 proximate to the top thereof. The cap 14 may then be slid down the cable 36 and onto the outer body 12, and the epoxy allowed to cure.

Advantageously, the cap 14 and actuator 104 may facilitate operation of electrode assembly 10 as compared to conventional electrode assemblies when replacing the filling electrolytic solution 72. By way of example, the above described features may allow the user to simultaneously grip the cap 14 securely with the fingers of their left or right hand by making a fist, and depress the actuator 104 using the thumb of the same hand. Fixing the cap 14 relative to the outer body 12 of electrode assembly 10 may also allow the user to hold the electrode assembly 10 anywhere on the cap 14 or outer body 12 when pressing the actuator 104, further simplifying operation. Embodiments of the invention may thereby facilitate one-handed draining of the filling electrolytic solution 72.

The terminology used herein is for the purpose of describing particular embodiments only and is not intended to be limiting of the embodiments of the invention. As used herein, the singular forms “a”, “an” and “the” are intended to include both the singular and plural forms, and the terms “and” and “or” are each intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”. In addition, the dimensions some parts of the drawings may not be drawn to scale, or may be exaggerated for the sake of clarity.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. An electrode assembly, comprising:
a hollow outer body including an upper portion and a lower end having an edge that defines a lower opening;
a cap operatively coupled to the upper portion of the hollow outer body such that the cap has a fixed relationship with the hollow outer body;
a biasing assembly configured to provide a first force and operatively coupled to one or more of the hollow outer body and the cap;
an actuator operatively coupled to the biasing assembly such that the first force urges the actuator into a first position relative to the hollow outer body; and
a sensing electrode operatively coupled to the actuator and including a stopper having a stopper outer surface that abuts the edge of the hollow outer body when the actuator is in the first position.

2. The electrode assembly of claim 1, wherein:
the actuator is configured to, in response to application of a second force to the actuator in opposition to and sufficient to overcome the first force, move from the first position to a second position relative to the hollow outer body, and
the stopper outer surface is separated from the edge of the hollow outer body when the actuator is in the second position.

3. The electrode assembly of claim 1, wherein the hollow outer body defines a chamber, and further comprising:
a filling electrolytic solution contained by the chamber; and
a liquid junction operatively coupling the filling electrolytic solution to a sample solution, the liquid junction forming between the stopper outer surface and the edge of the hollow outer body when the electrode assembly is immersed in the sample solution.

4. The electrode assembly of claim 1, wherein the cap includes an upper opening, and the actuator includes a button that extends upward through the upper opening.

5. The electrode assembly of claim 4, further comprising:
a cable assembly including a cable,
wherein the button includes a passage configured to pass the cable.

6. The electrode assembly of claim 1, wherein:
the sensing electrode includes a hollow inner body having an upper end; and
the actuator includes a sleeve having a channel configured to receive the upper end of the hollow inner body.

7. The electrode assembly of claim 6, further comprising:
a cable assembly including a cable having a distal end and a conductor, wherein
the upper end of the hollow inner body includes an inner body opening,
the sensing electrode includes a sensing lead having a proximal end, the proximal end including an elastic feature positioned in the hollow inner body of the sensing electrode proximate to the inner body opening,
the distal end of the cable is positioned in the channel of the sleeve opposite the inner body opening, and
the conductor extends from the cable into the inner body opening a distance sufficient to compress the elastic feature of the proximal end of the sensing electrode.

8. The electrode assembly of claim 6, wherein the sleeve includes an annular groove, and the biasing assembly includes an elastic member having a first end and a second end, the first end being operatively coupled to the one or more of the hollow outer body and the cap, and further comprising:
a retaining ring positioned in the annular groove and operatively coupled to the second end of the elastic member.

9. The electrode assembly of claim 8 wherein the first end of the elastic member is operatively coupled to the upper end of the hollow outer body.

10. The electrode assembly of claim 6, wherein the sleeve includes an annular groove, the hollow outer body includes an inner surface, and further comprising:
an O-ring positioned in the annular groove, the O-ring providing a fluidic seal between the sleeve and the inner surface of the hollow outer body.

11. The electrode assembly of claim 6, wherein the sleeve has a bore on the lower end thereof, and further comprising:
a bushing positioned in the bore of the sleeve, the bushing operatively coupling the hollow inner body to the sleeve.

12. The electrode assembly of claim 6, wherein the cap includes an upper opening, and the actuator includes a button having a button upper portion that extends upward through the upper opening, and a button lower portion that is operatively coupled to the sleeve.

13. The electrode assembly of claim 11, wherein the hollow inner body includes a body outer surface, the sleeve includes an annular recess between the bore and the channel, and further comprising:
an O-ring positioned in the annular recess, the O-ring providing a fluidic seal between the sleeve and the body outer surface.

14. The electrode assembly of claim 1, wherein the hollow outer body includes a fill-hole, and further comprising a plug configured to selectively seal the fill-hole and a tether that operatively couples the plug to the hollow outer body.

15. The electrode assembly of claim 1 further comprising:
a helical tube positioned in the hollow outer body, wherein the sensing electrode extends axially through the helical tube.

16. The electrode assembly of claim 15, wherein the helical tube contains a reference electrolytic solution.

17. The electrode assembly of claim 16 wherein the hollow outer body defines a chamber containing a filling electrolytic solution, and the helical tube is capped by a porous plug that provides a liquid junction between the reference electrolytic solution and the filling electrolytic solution.

18. The electrode assembly of claim 1 wherein the sensing electrode contains a sensing electrolytic solution.

19. The electrode assembly of claim 1 wherein the sensing electrode includes:
a hollow inner body that extends axially through the hollow outer body; and
membrane that is coupled to the hollow inner body by the stopper and extends axially outward from the lower end of the hollow outer body.

20. The electrode assembly of claim 19, wherein the sensing electrode includes a cylindrical section that operatively couples the membrane to the stopper.
